(19) United States
(12) Patent Application Publication
(10) Pub. No.: US 2011/0297514 A1
(43) Pub. Date: Dec. 8, 2011

(54) EQUIPMENT OF CONVEYANCE WHICH CAN ROTATE REPEAT

(76) Inventor: Seung Ju Baek, Kyongki-do (KR)

(21) Appl. No.: 13/002,651

(22) PCT Filed: Nov. 28, 2008
(86) PCT No.: PCT/KR2008/007030

§ 371 Date: Jan. 4, 2011

(30) Foreign Application Priority Data
Jul. 7, 2008 (KR) 10-2008-0065421

(51) Int. Cl. B65G 21/10

(52) U.S. Cl. 198/861.1

(57) ABSTRACT

The present invention, rotation style screen moving system is not a traditional moving system but a a working process which uses oil pressure of bottom, the opened upper part of the screen becomes about ⅓ lower, there is no the working board (9) in the upper part, and because the height of an adulteration moving conveyance (3) becomes lower, it makes maintenance and management easier so we can reduce set up cost. Also, the screen (2) was made as a rotation style that the lake arm (4) can rotate to go back to it original place, so it can be made as lower opened part compared with other system.

### TECHNICAL FIELD

For the present invention, an equipment of conveyance which can rotate repeat, the lake arm (4) turns 270°˜360°, an adulteration comes forward to the front, and the adulteration moving conveyance (3) is located in the front part, so there are big usable spaces, and it helps the size of whole storage become small.

Also, it can be set up a hoist for maintenance 2 m or lower than other traditional way, you can reduce set up fee and prevent accidents.

The present invention, an equipment of conveyance which can rotate repeat is used as disposal equipment of adulteration in the water supply and drainage system.

### BACKGROUND ART

The background of the present invention is the fixed screen system that fix between screen bars, but a hoist for maintenance and the adulteration moving conveyance are set up high to be dangerous.

Therefore, there have been always dangers, and the cost of making screen system have been high.

### DISCLOSURE

### Technical Problem

The problems that the present invention, AN EQUIPMENT OF CONVEYANCE WHICH CAN ROTATE REPEAT, wants to solve;

1. Reducing cost

2. Reducing risk of danger by lowering the hoist for maintenance

3. No need for a work way

4. Working without fixing fix bars

### Technical Solution

The solutions of the technical problem of the present invention, AN EQUIPMENT OF CONVEYANCE WHICH CAN ROTATE REPEAT, are as follows;

1. By using the pulley system by oil pressure cylinder of bottom (1) not using traditional rotation system to make the open part of screen top ⅓ lower, so you will not need an operation board, height of the adulteration moving conveyance (3) becomes lower to keep and to manage easily to reduce the cost of making system.

2. By setting up the height of open top part of screen (2) 2 m or lower than traditional way, you can reduce cost and make high safety.

3. No need for a work way because of setting up the adulteration moving conveyance (3) in the front.

4. The space among screen bars are always same for the guide gear (6) shaped as a pyramid of seven-angle are stuck in every layer among screen bars (8) without fixing the fix bars.

### ADVANTAGEOUS EFFECTS

The effectiveness of the present invention is as follows;

1. The lake arm (4) turns 270°˜360°, an adulteration comes forward to the front, and the adulteration moving conveyance (3) is located in the front part, so there are big usable spaces, and it helps the size of whole storage become small.

2. In order to protect collision of moving roll (5) of lake arm (4) that pulls up the alteration and to improve the capacity, teflon pad (7) is put on the both side of moving rail, and in order to make an exact fix to the starting point of lower part, guide gear (6) is set up to improve the effectiveness.

3. Because screen bar (8) is not fixed, lake arm (4) is permeated deep, and the guide gear (6) shaped as a pyramid of seven-angle is set up among screen bars, so foreign body can be filtered well.

4. By reducing size, you can reduce the production cost and make safety high.

[Description of Drawings]

| | |
|---|---|
| 1. a oil pressure cylinder | 2. Screen |
| 3. Moving Conveyance | 4. Lake Arm |
| 5. Moving roll | 6. Guide gear |
| 7. teflon pad | 8. Screen bar |
| 9. Working Board | 10. Protecting cover |
| 20. Direction change board | |

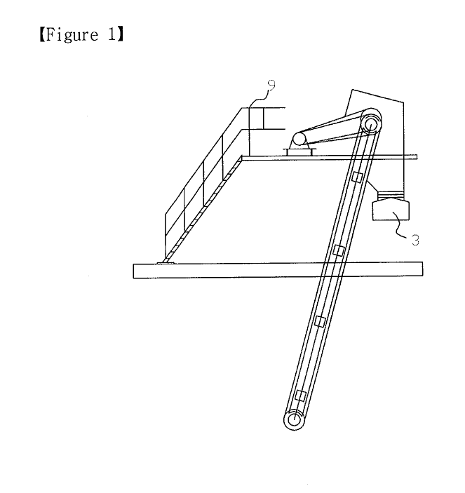

FIG. 1. is a brief cross sectional figure of the traditional screen moving system.

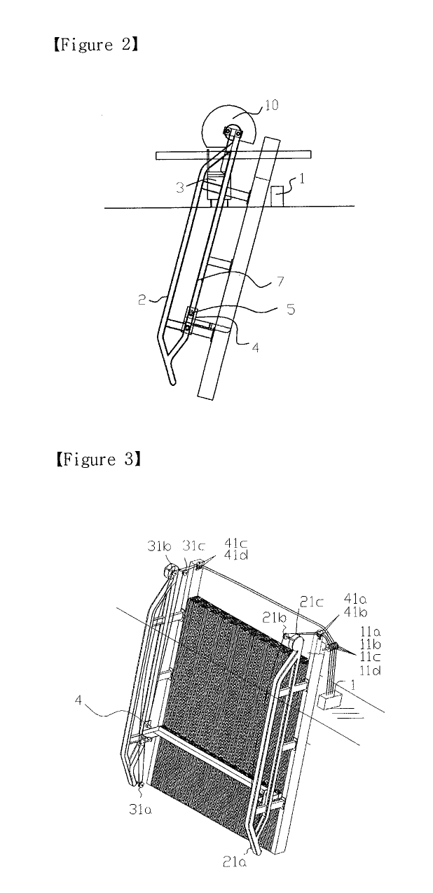

FIG. 2. is a brief cross sectional figure of the present invention that the relationship between pulleys before working.

FIG. 3. is an enlarged squint figure that shows the protection of the present intention is omitted during working.

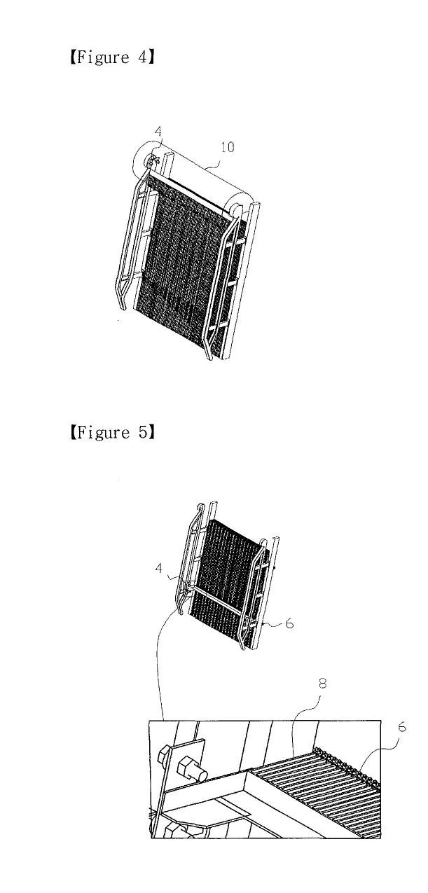

FIG. 4. is a brief squint figure that shows the alteration disposal of the present invention, an equipment of conveyance which can rotate repeat.

FIG. 5. is an enlarged squint figure that shows the relationship between guide gear and lake arm of the present invention, an equipment of conveyance which can rotate repeat.

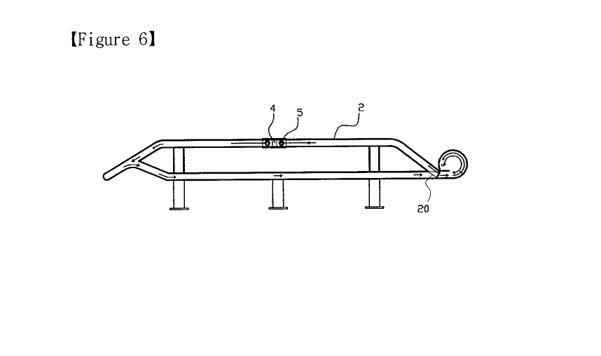

FIG. 6. is a brief moving cross sectional figure of the present invention, an equipment of conveyance which can rotate repeat.

### BEST MODE

The detailed information of the present invention, the best form of using this invention, is explained through the attached figures.

FIG. 1. is a brief cross sectional figure of the traditional screen moving system. FIG. 2. is a brief cross sectional figure of the present invention that the relationship between pulleys before working. FIG. 3. is an enlarged squint figure that shows the protection of the present intention is omitted during working. FIG. 4. is a brief squint figure that shows the alteration disposal of the present invention, an equipment of conveyance which can rotate repeat.

FIG. 5. is an enlarged squint figure that shows the relationship between guide gear and lake arm of the present invention, an equipment of conveyance which can rotate repeat. FIG. 6. is a brief moving cross sectional figure of the present invention, an equipment of conveyance which can rotate repeat.

As shown in the FIG. 3., lake arm (4) is located on the moving way of screen (2), the traditional skill, control pulleys ((11a)(11b)(11c)(11d)) by oil pressure cylinder (1), moving pulleys (21a)(21b)(21c)(31a)(31b)(31c), conversion pulleys (41a)(41b)(41c)(41d), moving roll (5) is set up by pull and push system, and the lake arm (4) rotates 270°˜360° in the upper part of discharge, the alteration comes forward to the front, and the alteration moving conveyance (3) is located in the front, so there is a big space behind of the screen to use, and the whole system becomes smaller.

Also, in order for the lake arm (4) pulling up the adulteration to move easily, moving roll (5) is set up, and in order to protect the collision of moving roll (5), and in order to improve the function, teflon pad (7) is put on the both sides of moving rail to be able to move easily, and in order to the exact fix on the starting point of lower part, you can keep a space without fixing with traditional fix bar, and screen bar (8) is not fixed, so lake arm (4) is permeated deep, the guide gear (6) shaped as a pyramid of seven-angle among screen bars (8) is set up among screen bars (8), so foreign body can be filtered by rotating lake arm (4).

In addition to that, the direction change board that is set up in order to assist the direction change of lake arm (4) on the upper part of screen (3), and when it is moved to the upper part, the direction change board (20) moves to up by collision of lake arms (4), and after rotating and moving down, it can move to moving rail, so it helps it go down.

At last, we can reduce production cost by making smaller size, for the moving conveyance is located in the front, and work way is not needed, we can make high safety by lowering the height of a hoist for maintenance.

1. The screen (3) that lake arm (4) is located on the moving way of screen (2), the traditional skill, control pulleys ((11a)(11b)(11c)(11d)) by oil pressure cylinder (1), moving pulleys (21a)(21b)(21c)(31a)(31b)(31c), conversion pulleys (41a)(41b)(41c)(41d), moving roll (5) is set up by pull and push system, and the lake arm (4) rotates 270°˜360° in the upper part of discharge, the alteration comes forward to the front, and the alteration moving conveyance (3) is located in the front; moving roll (5) that moving adulteration conveyance (3) is set up in front of the above screen (3) and that makes the lake arm (4) move easy; teflon pad (7) that was put on the both sides of moving rail in order to protect collision of the above moving roll (5) and to make it move easily; guide gear (6) that points out the starting point of the below part and that keep the equal space among screen bars (8) without using the traditional fix bar in order to fix; direction change board (20) that is set up in order to assist the direction change of the above lake arm (4) on the upper part of the above screen (3); and rotation style screen moving system that makes high safety by lowering the height of a hoist for maintenance.

2. In the claim 1, the rotation style screen moving system that uses the behind space of the above screen (3), and that reduces the production cost.

3. In the claim 1, rotation style screen moving system that the above guide gear (6) was produced as a shape of a pyramid of seven-angle, and that was made to rotate by lake arm and permeated deep to be able to filter foreign body

4. In the claim 1, rotation style screen moving system that there is a protection cover (10) in the upper part of the above screen (3) for an adulteration not to be separated and that makes the adulteration move easily to the moving conveyance.

5. In the claim 1, rotation style screen moving system that there is a direction change board set up to assist the direction change of the above lake arm (4) in the upper part of screen (3), and when it moves to the upper part, it moves by the collision of the direction change board (20) and lake arm (4), and when it moves to the below part, it moves to the moving rail in the upper part by the direction change board (20), so it moves down.
